(19) United States
(12) Patent Application Publication
(10) Pub. No.: US 2016/0081767 A1
(43) Pub. Date: Mar. 24, 2016

(54) Dental Retainer

(71) Applicant: ClearRetain, LLC, American Fork, UT (US)

(72) Inventors: Lyman Rick Metcalf, Orem, UT (US); Steven Gardner, American Fork, UT (US)

(21) Appl. No.: 14/860,113

(22) Filed: Sep. 21, 2015

Related U.S. Application Data
(60) Provisional application No. 62/053,745, filed on Sep. 22, 2014.

(51) Int. Cl. A61C 7/08

(52) U.S. Cl. CPC A61C 7/08

(57) ABSTRACT

An orthodontic device for retaining teeth in position, or for making minor adjustments to tooth position. The dental retainer includes a rigid lingual portion or arch, and a more flexible and comfortable labial portion or arch, arranged so as to allow the cutting surfaces of the upper and lower molar teeth to meet. Small protrusions of harder material may be located on the inner surface of the labial portion to fit between the teeth in order to prevent relapse of tooth position.

### BACKGROUND

1. State of the Art

The present invention relates to dental retainers, used to make minor adjustments to the position of teeth or to hold teeth in place after the teeth have been adjusted by braces.

2. Field of Art

During orthodontia, a patient's teeth are straightened or otherwise reoriented in order to provide a more pleasing smile and to correct a variety of bite misalignments which can damage teeth, cause temporomandibular joint dysfunction, and interfere with the ability to chew properly. In order to properly align the teeth, it is common to apply braces to the teeth and then modify them by applying tension with wires.

Because many patients find braces unsightly, there has been a growing popularity with less visible treatments such as Invisalign® braces, in which a series of clear, thermoformed trays are fitted to a patient's mouth to gradually reposition the teeth.

After the patient's teeth have reached the desired position and the brackets, trays, or other orthodontic devices are removed, the teeth may shift or twist out of alignment over time. In order to prevent this movement, or to make minor corrections to tooth placement, an orthodontist will supply the patient with a retainer. This device is usually a combination of rigid plastic which rests against the roof of the mouth, and wire which extends along the exterior surface of the teeth. To ensure that the retainer will properly hold the teeth in place, the retainer typically is cast to fit a negative mold of the patient's mouth.

Successful results from any retainer depend upon the cooperation of the patient, as the patient has the choice of wearing or not wearing the retainer. In the event that a patient fails to wear the retainer for a period of time, difficulty can be experienced in thereafter placing the retainer due to relapse of teeth positions.

Such retainers should be worn for prolonged periods. While the rigid plastic of a conventional retainer holds teeth in position quite well, a conventional retainer usually cannot effectively be used to make final adjustments to tooth position. They are also often unsightly because a wire must pass across the incisors, where the wire can easily be seen. Because of the embarrassment often accompanying the use of such devices, there is a significant non-compliance rate among those who have had braces. This often results in a smile that is less pleasing than originally obtained by use of the braces.

In an attempt to overcome this issue, a common solution is to fit the patient with a thermoformed plastic tray, which is less expensive than a conventional retainer. Patients who chose a treatment such as Invisalign® may be counseled to continue wearing the last tray of the series for years. Such an approach is preferred by many because the thermoformed plastic tray is generally clear and less noticeable than a metal wire extending along the person's teeth.

While the use of clear plastic trays rather than conventional retainers is advantageous aesthetically, they present other issue For Example, a patient may not be able to fully bite down while wearing a clear plastic tray, because plastic covers the cutting surface of each tooth. Over time, this inability to fully close the jaw leads to strain on the temporomandibular joint (TMJ).

Stress on the TMJ can have serious clinical consequences, because a variety of muscles, tendons, and ligaments attach to this joint. The TMJ may become swollen, causing activities such as speaking and chewing to be painful. Patients frequently develop headaches, clicking or popping in the jaw, and shoulder or back pain. Patients may find that their bite position changes, so that the teeth of the upper and lower jaw do not properly align after the clear plastic tray is removed.

Because of these disadvantages, patients may neglect to wear either an unsightly retainer or a clear plastic tray. Without a retainer, teeth frequently move or twist out of the desired position over time. Repairing these misalignments requires patient time and expense.

Thus, there is a need for an improved dental retainer.

### SUMMARY OF THE INVENTION

The following summary of the present invention is not intended to describe each illustrated embodiment or every possible implementation of the invention, but rather to give illustrative examples of application of principles of the invention.

In some embodiments, the present invention may include a lingual and a labial material, the labial material being formed of a flexible plastic material, and the lingual material being a rigid plastic.

In accordance with one aspect of the present disclosure, the two materials of the dental retainer may be linked together with wire.

In accordance with one aspect of the disclosure, the dental retainer lingual and labial materials may be molded to precisely fit the shape of teeth.

In accordance with another aspect of the disclosure, the flexible labial material may be substantially clear.

In accordance with one aspect of the disclosure, the dental retainer extends around the full arch of a mammal's teeth.

In accordance with still yet another aspect of the disclosure, the flexible labial material is equipped with small projections which fit in between the teeth.

In accordance with still another aspect of the disclosure, the small projections are formed using the rigid labial material.

In accordance with still another aspect of the disclosure, the dental retainer is equipped with a compressible member, anchored in the lingual material, which is configured to apply pressure to the lingual surfaces of at least one tooth.

In accordance with still another aspect of the disclosure, the compressible member comprises a mushroom spring wire or a coil spring.

On or more of these and other aspects of the present disclosure may be realized in a dental retainer as shown and described in the following figures and related description. It will be appreciated that various embodiments of the invention may not include each aspect set forth above and aspects discussed above shall not be read into the claims unless specifically described therein.

### BRIEF DESCRIPTION OF THE DRAWINGS

Various embodiments of the present disclosure are shown and described in reference to the numbered drawings wherein:

FIG. 1, FIG. 2 and FIG. 3 illustrate conventional retainers made in accordance with the teachings of the prior art;

FIG. 4 illustrates an overhead view of one aspect of the dental retainer, featuring a rigid plastic lingual material, a flexible labial material, and connecting wires made in accordance with the principles of the present disclosure;

FIG. 5 shows a close-up view of a portion of the dental retainer;

FIG. 6 shows an bottom perspective view of the dental retainer of FIG. 6 and

FIG. 6 positioned on a set of teeth;

FIG. 7 shows overhead view of one aspect of the dental retainer fitted to the full arch of a patient's teeth, and illustrates the compressible member anchored in the rigid lingual material, positioned to apply pressure to four of the patient's teeth;

FIG. 8 illustrates a side view of the present invention fitted to a patient's teeth, including the clear, flexible labial material;

It will be appreciated that the drawings are illustrative and not limiting of the scope of the invention which is defined by the appended claims. The embodiments shown accomplish various aspects and objects of the invention. It will be appreciated that it is not possible to clearly show each element and aspect of the present disclosure in a single figure, and as such, multiple figures are presented to separately illustrate the various details of different aspects of the invention in greater clarity. Similarly, not all configurations or embodiments described herein or covered by the appended claims will include all of the aspects of the present disclosure as discussed above.

### DETAILED DESCRIPTION

Various aspects of the invention and accompanying drawings will now be discussed in reference to the numerals provided therein so as to enable one skilled in the art to practice the present invention. The skilled artisan will understand, however, that the methods described below can be practiced without employing these specific details, or that they can be used for purposes other than those described herein. Indeed, they can be modified and can be used in conjunction with products and techniques known to those of skill in the art in light of the present disclosure. The drawings and the descriptions thereof are intended to be exemplary of various aspects of the invention and are not intended to narrow the scope of the appended claims. Furthermore, it will be appreciated that the drawings may show aspects of the invention in isolation and the elements in one figure may be used in conjunction with elements shown in other figures.

Reference in the specification to “one embodiment,” “one configuration,” “an embodiment,” or “a configuration” means that a particular feature, structure, or characteristic described in connection with the embodiment may be included in at least one embodiment, etc. The appearances of the phrase “in one embodiment” in various places may not necessarily limit the inclusion of a particular element of the invention to a single embodiment, rather the element may be included in other or all embodiments discussed herein.

Furthermore, the described features, structures, or characteristics of embodiments of the present disclosure may be combined in any suitable manner in one or more embodiments. In the following description, numerous specific details may be provided, such as examples of products or manufacturing techniques that may be used, to provide a thorough understanding of embodiments of the invention. One skilled in the relevant art will recognize, however, that embodiments discussed in the disclosure may be practiced without one or more of the specific details, or with other methods, components, materials, and so forth. In other instances, well-known structures, materials, or operations may not be shown or described in detail to avoid obscuring aspects of the invention.

Before the present invention is disclosed and described in detail, it should be understood that the present invention is not limited to any particular structures, process steps, or materials discussed or disclosed herein, but is extended to include equivalents thereof as would be recognized by those of ordinarily skill in the relevant art. More specifically, the invention is defined by the terms set forth in the claims. It should also be understood that terminology contained herein is used for the purpose of describing particular aspects of the invention only and is not intended to limit the invention to the aspects or embodiments shown unless expressly indicated as such. Likewise, the discussion of any particular aspect of the invention is not to be understood as a requirement that such aspect is required to be present apart from an express inclusion of that aspect in the claims.

It should also be noted that, as used in this specification and the appended claims, singular forms such as “a,” “an,” and “the” may include the plural unless the context clearly dictates otherwise. Thus, for example, reference to “a spring” may include an embodiment having one or more of such springs, and reference to “the layer” may include reference to one or more of such layers.

As used herein, the term “substantially” refers to the complete or nearly complete extent or degree of an action, characteristic, property, state, structure, item, or result to function as indicated. For example, an object that is “substantially” enclosed would mean that the object is either completely enclosed or nearly completely enclosed. The exact allowable degree of deviation from absolute completeness may in some cases depend on the specific context, such that enclosing the nearly all of the length of a lumen would be substantially enclosed, even if the distal end of the structure enclosing the lumen had a slit or channel formed along a portion thereof. The use of “substantially” is equally applicable when used in a negative connotation to refer to the complete or near complete lack of an action, characteristic, property, state, structure, item, or result. For example, structure which is “substantially free of” a bottom would either completely lack a bottom or so nearly completely lack a bottom that the effect would be effectively the same as if it completely lacked a bottom.

As used herein, the term “about” is used to provide flexibility to a numerical range endpoint by providing that a given value may be “a little above” or “a little below” the endpoint while still accomplishing the function associated with the range.

As used herein, a plurality of items, structural elements, compositional elements, and/or materials may be presented in a common list for convenience. However, these lists should be construed as though each member of the list is individually identified as a separate and unique member.

Concentrations, amounts, proportions and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually. This same principle applies to ranges reciting only one numerical value as a minimum or a maximum. Furthermore, such an interpretation should apply regardless of the breadth of the range or the characteristics being described.

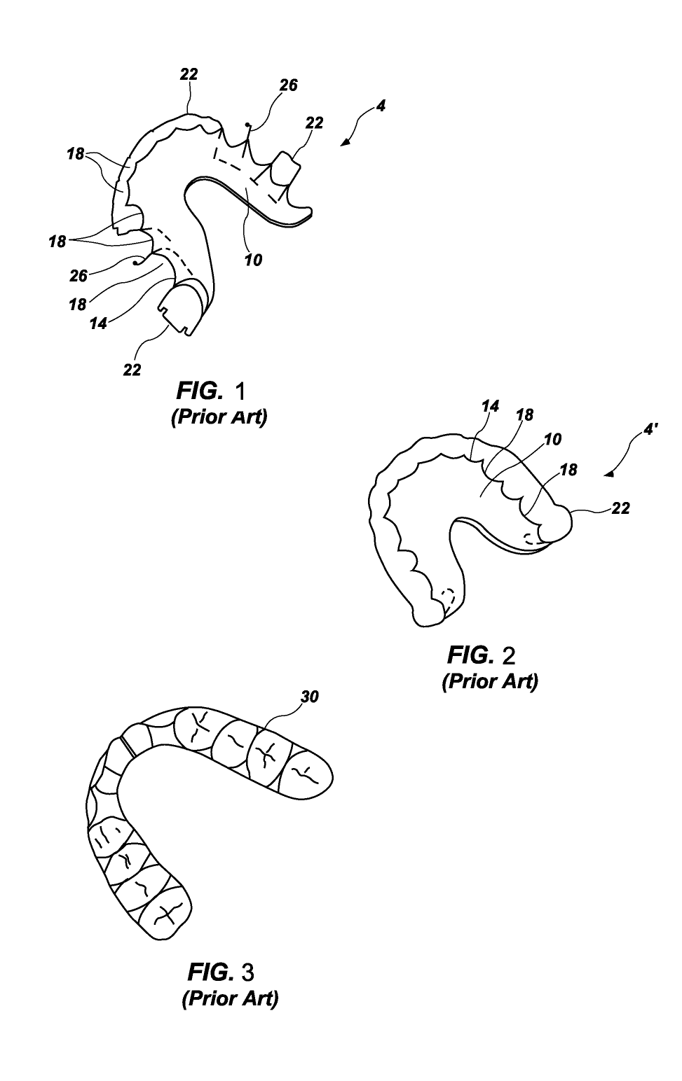

Turning now to FIG. 1, there is shown a perspective view of a retainer, generally indicated at 4. The retainer 4, which is commonly referred to as a Hawley retainer, is well known in the art. The retainer 4 includes a generally rigid plastic (typically an acrylic) lingual arch 10 which is shaped to rest against the roof of the patient's mouth. The lower periphery 14 of the arch 10 has a plurality of curvatures 18 shaped to align with the lingual side of the patient's teeth and thereby hold them in place. This is typically accomplished by forming the lingual arch 10 on a negative mold of the patient's teeth (i.e. a casting of the teeth formed by filling a mold of the patient's mouth).

A plurality of wire loops 22 are anchored in the lingual arch 10 and extend from the lingual arch to wrap around various teeth, holding them in place. Two additional support wires 26 may also be used to help anchor the retainer in place.

FIG. 2 shows a retain configuration 4′ similar to that of FIG. 1, but only one large loop 22 is used to extend around the patient's teeth. This configuration is commonly called a Hawley arch. It is well known that patients often dislike using this form of retainer because the wire loop 22 which wraps around the front teeth is very visible. While attempts have been made to use clear wires, the clear wires are prone to breaking.

FIG. 3 shows an alternate prior art retainer configuration, generally indicated at 30. Rather than using a lingual arch made of a rigid material, the retainer 30 is formed directly on the teeth (typically on a negative mold). This may be done by vacuum forming a polypropylene or polyvinylchloride (PVC) material, typically 0.020″ or 0.030″ thick, directly on the teeth (often called an Essix retainer) or by thermoforming an engineered polyurethane, such as that sold by Bay Materials, LLC of Melo Park, Calif. under the brand name ZENDURA.

While the vacuum formed and thermoformed retainers are advantageous in that they are less visible than a metal wire, they have the disadvantages of generally being less rigid and less tightly formed to the teeth, and are thereby less able to hold teeth in the proper alignment. Additionally, because they coat the biting surface of the teeth, they can interfere with proper tooth alignment and can cause headaches or aggravate TMJ issues in some patients.

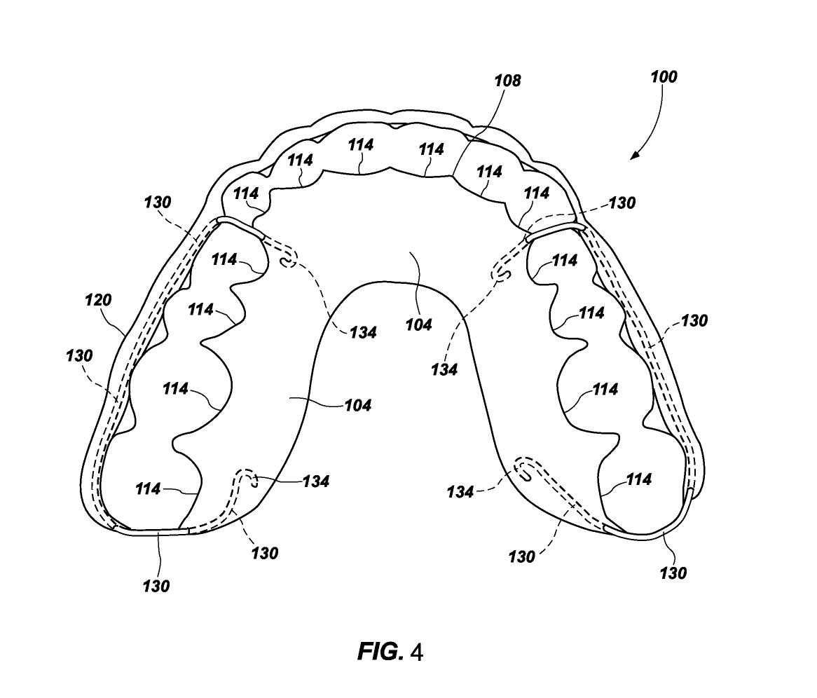

Turning now to FIG. 4, there is shown an overhead view of a dental retainer, generally indicated at 100, made in accordance with the teachings of the present invention. The dental retainer 100 includes a generally rigid lingual arch 104 which is generally formed in accordance with the teachings of the prior art. The lingual arch 104 may be made from a variety of materials, although acrylics are most common. The lingual arch 104 includes a periphery 108 which is shaped to engage or mirror the curvatures of the lingual side of a patient's teeth. Thus, a plurality of scallops or curvatures 114 is shown. As with the prior art, the lingual arch 104 will typically be formed on a negative mold of the patient's teeth.

Rather than using a wire front loop (similar to front loop 22 in FIG. 1), the retainer 100 uses a sheet of plastic or formable polymer material (e.g. polypropylene, polyvinylchloride or engineered polyurethane) to form a more flexible labial arch 120. The flexible labial arch 120 is formed to the front surface of the patient's teeth. On the front teeth (i.e. the canines forward) the labial arch may be configured to wrap over the biting surface. Thus, the front portion of the labial arch is relatively unnoticeable. The material forming the labial arch may be disposed only along the sides of the bicuspids and molars, so as to not be disposed on the chewing surface. Such a configuration avoids interference with proper biting, thereby reducing the risk of headaches and TMJ issues.

The lingual arch 104 and the labial arch 120 may be connected to one another by a pair of wire loops 130, portions of which are shown in dashed lines where embedded in the lingual arch 104 and the labial arch 120. The wire loops 130 may be fixedly anchored via anchors 134 in the rigid lingual material 104. While the presently formed embodiments discussed in the present disclosure have the lingual arch 104 formed from acrylic and the labial arch 120 formed from a formable polymer such as polypropylene, polyvinylchloride or polyurethane, it will be appreciated that other materials may be used.

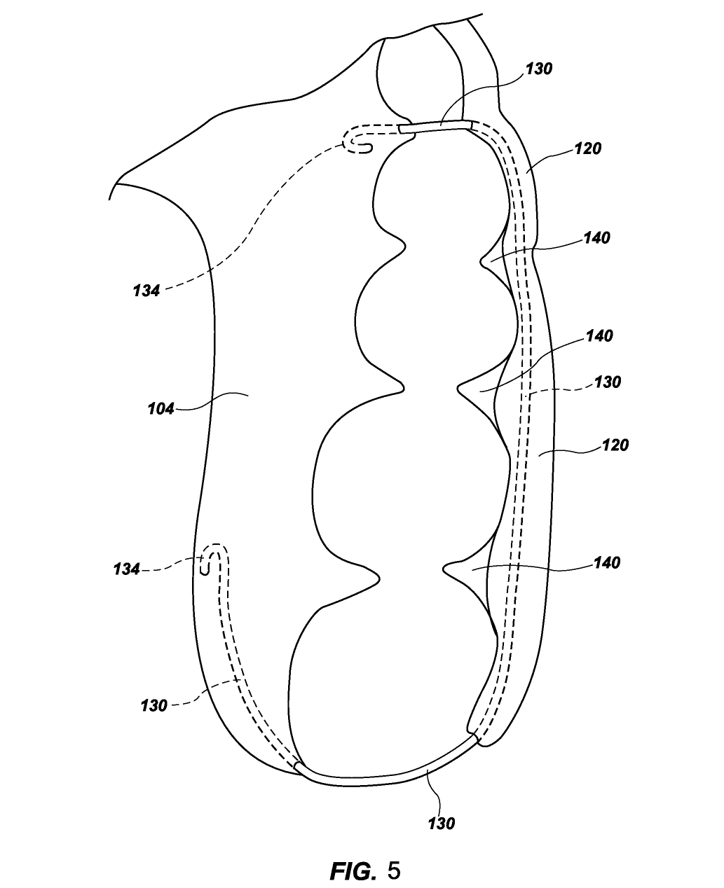

As was mentioned above, one challenge with formed materials is that they generally do not closely conform to the patient's teeth and thus allow movement. This is especially so because the material is also more flexible than the acrylic used for the lingual arch 104. FIG. 5 shows a close-up of a portion of the retainer 100 of FIG. 4. It has been found in accordance with one aspect of the present invention that the retention of the retainer and holding of the teeth can be improved by adding a plurality of more rigid projections 140 which extend from the more flexible material forming the labial arch 120. The more rigid projections 140 extend inwardly from the labial arch and better fill the crevices between the teeth, thereby providing both a better fit and less ability for the teeth to move because of the rigid material.

The projections 140 may be made in several ways and attached to the labial arch 120. For example, the projections 140 may be made by filling the crevices with a generally rigid acrylic and then vacuum forming or thermoforming the more flexible polymer on top of the acrylic. In the alternative, the labial arch may be formed first, the more rigid material forming the projections placed on the mold and the polymer of the labial arch bonded or otherwise fastened to the more rigid projections. If necessary, the projections can be built up in several steps to achieve a desired size which will better hold the retainer 100 in place on the teeth of the patient.

One of the advantages of selecting a clear material for the flexible labial material 120 and forming projections 140 thereupon is that the device becomes essentially invisible when in a patient's mouth. (It will be appreciated that any means, known to one of skill in the art, of fitting the flexible labial material 120 to the patient's teeth are herein encompassed, including thermoforming, imprinting, vacuum-forming, etc.) Additionally, because in some embodiments the flexible labial material extends the full length of the patient's arch of teeth, no wires or other sharp surfaces are exposed along the outer side of the teeth, increasing patient comfort. Moreover, it is believed that the retainer 100 will obtain tooth position retention on par or better than that of a traditional Hawley retainer (FIGS. 1 and 2) with the lack of visibility of a formed retainer (FIG. 3) while providing comfort which is equal to or greater than either prior art configuration.

One major technical issue is the ability to connect the more flexible formed plastic labial arch 120, the wire loops 130 and the more rigid lingual arch 104 together. While the wire loops 130 can be anchored in the material forming the lingual arch 104, it is difficult to get the wire material to bond to the material forming the more flexible labial arch 120. It has been found that the acrylic or other material used to form the lingual arch 104 can be used to anchor the metal wire 130 to the labial arch 120. Effectively, the wire is sandwiched between the flexible material forming the labial arch and the rigid material attached thereto. As noted above, the presence of the more rigid material on the labial arch allows for projections 140 to be made which nest in the grooves between the teeth. Thus, the acrylic layer or similar material forming the projections 140 also serves as an attachment agent for the wire loops 130 and labial arch 120.

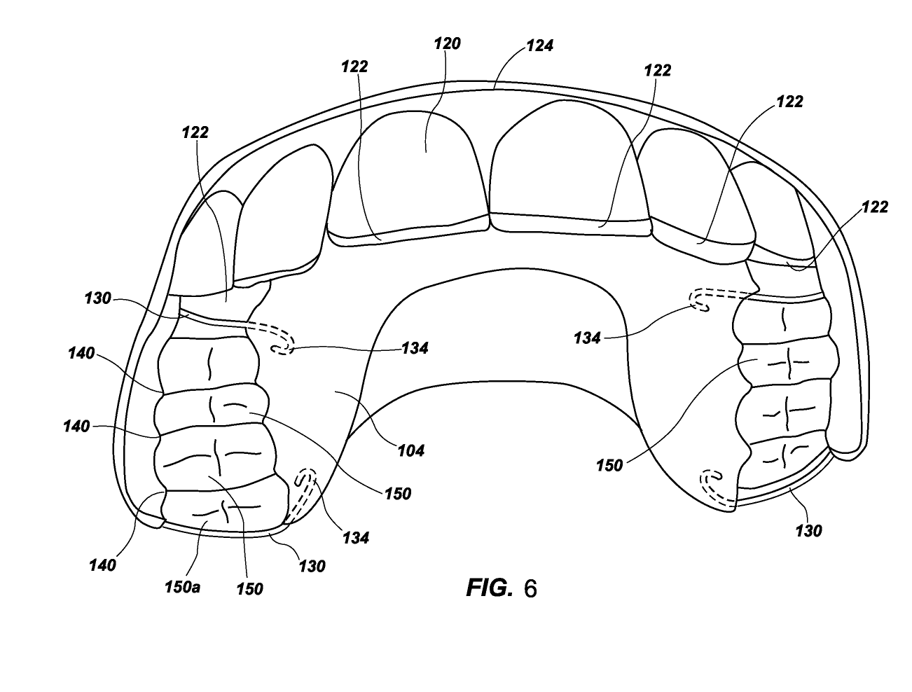

Turning now to FIG. 6, there is shown a bottom perspective view of the retainer 100 disposed on an upper set of teeth 150. As was mentioned previously, the portion of the labial arch 120 which extends around the front teeth, i.e. incisors and canines, is formed to have a lower edge 122 which wraps under and covers the biting edge of the front teeth. The top 124 of the labial arch typically extends close to or slightly above the top of the teeth. Thus, when a person smiles, a consistent surface is presented and the labial arch 120 is barely noticeable.

Behind the canines, the labial arch 120 is preferably sized so as to only extend along the sides of the bicuspids and molars so that the material forming the labial arch does not extend onto the biting surface of these teeth. This allows the teeth to maintain their proper engagement and prevents the discomfort which some people experience with conventional formed retainers. The wire loops 130 extend around the back of the rear-most molar 150a and extend up to a position between the canine and first bicuspid. The wire loops 130 serve the dual purpose of holding the labial arch and the lingual arch together and helping to hold the entire retainer 100 in the patient's mouth. Because of the projections 140 and the generally rigid lingual arch 104, the teeth 150 are provided very little space in which they can relapse into their former position. However, because of the flexibility of the labial arch, the retainer is still relatively easy to insert and remove then desired by the patient. Moreover, because the retainer is barely noticeable when worn, the likelihood of compliance by the patient is higher. Thus, teeth may be retained in a desired position better because 1) the retainer has a better fit to the teeth, 2) the retainer is worn more often, and 3) the retainer is comfortable and the risk of headaches and jaw pain is reduced.

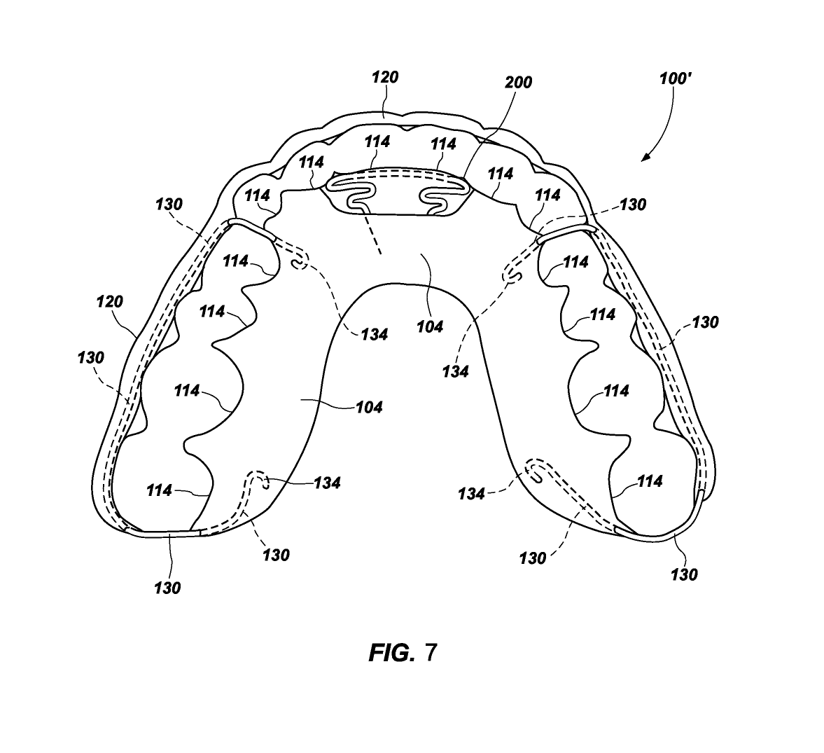

Turning now to FIG. 7, there is shown a top view of a retainer, generally indicated at 100′. The retainer 100′ includes the lingual arch 104 and the labial arch 120 and the other structures discussed above in FIGS. 5, 5 and 6. Such discussion of the components is incorporated by reference herein. While maintaining teeth in a desired orientation is the goal of wearing a retainer, it is common for people's teeth to shift over time. For those who have had braces and not been compliant in wearing the retainer, this is a frequent occurrence. Thus, even after having braces it is common for someone's teeth to turn or move out of alignment. Likewise, there are some people who have a few teeth which are out of alignment, but who do not want to use braces to correct minor misalignments. The configuration shown in FIG. 7 is configured to address such issues by including a biasing element 200 which is anchored in the lingual arch 104. Thus, as shown in FIG. 7, a wire has been shaped to form a spring to apply pressure to the two front incisors. It is common for people to have a nice smile with the exception that the two front incisors either extend forwardly at slightly different angles; the teeth extend slightly too far rearward, or may be turned inwardly along the medial surface. While a person with such a smile may not want to have braces, he or she may be willing to wear a retainer which is less noticeable.

The biasing element 200 may be formed to apply pressure to the back of the teeth. Teeth are prevented from moving too far forwardly by the portion of the labial arch 120 opposite the biasing element 200. Over time, the biasing element 200 will move the teeth into the desired position and resolve the issue. It will be appreciated that the biasing element 200 need not be positioned behind the front teeth, but can be located anywhere along the lingual arch 104. For example, if a canine, bicuspid or molar is out of place, a biasing element could be formed adjacent the tooth to urge it into a more preferred position. In light of the present disclosure, a person of ordinary still in the art would be able to shape a biasing element and mount it in the lingual arch to encourage such movement.

An advantage of the present dental retainer 100 is that it retains the durability and strength of a traditional retainer, due to the material of the rigid lingual arch 104. This material provides a solid anchor point for wire loops 130 or compressible biasing members 200. At the same time it provides the less noticeable look of a formed retainer and is more comfortable against the cheek that conventional wires. Additionally, there is no interference with the biting surfaces of the bicuspids and molars, making the retainer more comfortable for many people to wear.

A further advantage of using the flexible labial material in this manner is that the material may be thermoformed to fit over the cutting surfaces of a patient's incisors, without disrupting the fit of the patient's molars. This protects a patient's incisors from wear, and prevents damage to the incisors, while still allowing a patient's jaw to fully close.

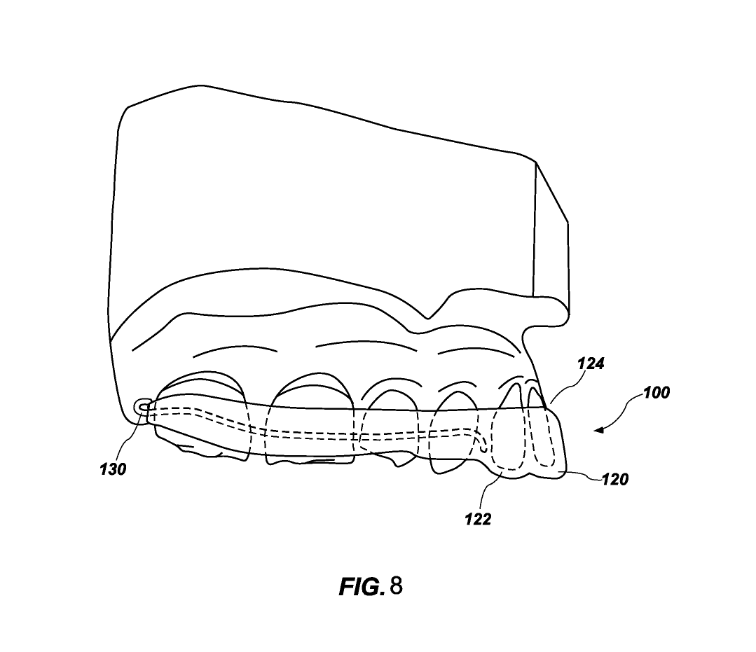

FIG. 8 illustrates a side view of the dental retainer 100 or 100′ fitted to a model of a patient's teeth. The retainer 100 includes clear, more flexible labial material forming the labial arch 120 which extends around the exterior of the teeth. The more rigid material forming the lingual arch is not visible because of the teeth.

Also shown in FIG. 8 is the wire loop 130 which holds the lingual arch and the labial arch 120 together. The wire loop 130 typically extends around the rear most molar and between the first bicuspid and the canine. This view shows more clearly how the chewing surfaces of the molars and bicuspids are not interfered with by the retainer. Additionally, because the material forming the labial arch 120 is preferably clear, the retainer is less noticeable when worn.

While the discussion of the retainer 100 or 100′ has been primarily regarding the upper retainer, it will be appreciated that a lower retainer may be formed in a similar manner both to reduce visibility and to increase comfort. Preferably both the chewing surfaces of the bicuspids and molars are left exposed.

Additionally, it will be appreciated that neither the lingual structure nor the labial structure need be formed in an arch. There may be situations, such as where a retainer is needed for only a few teeth, where the two sides of the retainer are linear or some other shape as needed.

Thus there is disclosed a dental retainer device and methods of using the same. It will be appreciated that numerous modifications may be made without departing from the scope and spirit of this disclosure. The appended claims are intended to cover such modifications.

What is claimed is:

1. A dental retainer comprising a lingual material and a labial material, wherein the lingual material is less flexible than the labial material, and wherein the lingual material and the labial material are fixedly attached together.

2. The dental retainer according to claim 1, wherein the lingual material and the labial material are fixedly attached together with at least one wire, wherein the wire passes through the labial material and is anchored in the lingual material.

3. The dental retainer according to claim 1, wherein the lingual material is shaped to conform to a lingual side of teeth of a mammal, and wherein the labial material is shaped to conform to a labial side of the teeth of the mammal.

4. The dental retainer according to claim 1, wherein the labial material is substantially transparent.

5. The dental retainer according to claim 1, wherein the labial material is shaped to conform to a full arch of a mammal's teeth.

6. The dental retainer according to claim 5, wherein the labial material is shaped by thermoforming to conform to the full arch of the mammal's teeth.

7. The dental retainer according to claim 1, further comprising projections bonded to the labial material, wherein the projections are shaped to fit between a mammal's teeth.

8. The dental retainer according to claim 7, wherein the projections are formed of the lingual material.

9. The dental retainer according to claim 1, further comprising at least one compressible member anchored in the lingual material, wherein the at least one compressible member is configured to apply pressure to at least one of a mammal's teeth.

10. The dental retainer according to claim 9, wherein the at least one compressible member is a mushroom spring wire.

11. The dental retainer according to claim 9, wherein the at least one compressible member is a coil spring.

12. A dental retainer comprising:
a lingual arch formed from a first material having a first rigidity and shaped to rest in a mammal's mouth behind teeth in the mammal's mouth and engage a lingual side of the teeth; and
a labial arch formed from a second material having a second rigidity less rigid than the first rigidity, the labial arch being shaped to engage a labial side of the teeth in the mammal's mouth.

13. The dental retainer of claim 12, wherein the lingual arch and the labial arch are attached together by a least one wire.

14. The dental retainer of claim 12, further comprising a plurality of projections on the labial arch formed by a material other than the second material.

15. The dental retainer of claim 14, wherein the projections on the labial arch are formed from the first material and bonded to the second material of the labial arch.

16. The dental retainer of claim 12, further comprising a biasing element attached to the lingual arch.

17. The dental retainer of claim 12, wherein the lingual arch is formed from acrylic and the labial arch is formed from at least one of the group consisting of polypropylene, polyvinylchloride and polyurethane.

18. The dental retainer of claim 12, having a plurality of wire loops, each of the loops being covered along a portion configured to extend along the outer labial surface of the teeth.

19. The dental retainer of claim 18, wherein the wire loops are shaped to extend around a rearward-most molar and a forward-most bicuspid of the mammal's teeth.

20. The dental retainer of claim 12, wherein the labial arch is shaped to cover a biting surface of incisors among the mammal's teeth and is shaped to not cover chewing surfaces of bicuspids and molars of the mammal's teeth.
